(19) United States
(12) Patent Application Publication
(10) Pub. No.: US 2020/0180160 A1
(43) Pub. Date: Jun. 11, 2020

(54) AUTOMATED WIRE DRAWING SYSTEM FOR SIDE WALL OF RAILWAY VEHICLE, AND WIRE DRAWING PROCESS

(71) Applicant: CRRC QINGDAO SIFANG CO., LTD., Shandong (CN)

(72) Inventors: Hao LU, Shandong (CN); Tiehao ZHANG, Shandong (CN); Chuanqi TAO, Shandong (CN); June JING, Shandong (CN)

(73) Assignee: CRRC QINGDAO SIFANG CO., LTD., Shandong (CN)

(21) Appl. No.: 16/305,676

(22) PCT Filed: Aug. 29, 2017
(86) PCT No.: PCT/CN2017/099406

§ 371 Date: Nov. 29, 2018

(30) Foreign Application Priority Data
Aug. 31, 2016 (CN) 201610788434.1

(51) Int. Cl. B25J 11/00; B24B 21/00

(52) U.S. Cl. CPC B25J 11/0065; B60S 3/006; B24B 21/006

(57) ABSTRACT

An automated wire drawing system for a side wall of a railway vehicle and a process method using the system for wire drawing operation are provided. The automated wire drawing system comprises a central control system, a robot, a wire drawing device, a railway, a laser measurement system, an offline programming software and an electronic system, so that the wire drawing operation of the side wall of a vehicle body can be automatically finished. The process method can realize the automated flexible and intelligent wire drawing operation, the change of the surface shape of a work piece within a certain range can be automatically adopted, and a constant normal wire drawing force is always maintained, to achieve the optimal wire drawing effect.

### TECHNICAL FIELD

The present disclosure relates to a wire drawing system and an adapted wire drawing process, in particular to the wire drawing system and the wire drawing process suitable for automated wire drawing of a side wall of a railway vehicle.

### BACKGROUND

Generally, a vehicle body of a railway vehicle mostly adopts a painted vehicle body to improve the performance of appearance decoration, namely, adopting paint coating of surface treatment method. The general coating procedure is: pre-treatment—primer—putty—inter coating—top coating. The whole process is complicated, time-consuming and labor-intensive.

The multi-painted vehicle body does not use putty and paint, which reduces welding wire and gas consumption. It can not only reduce the production cost, but also reduce the weight of the vehicle body and reduce consumption. It has clear technical advantage and competitiveness.

### SUMMARY

The main object of the present disclosure is to solve the problems and shortcomings mentioned above, and provide an automated wire drawing system and a wire drawing process for a surface treatment of the side wall of the vehicle body of the railway vehicle to produce the side wall of the vehicle body of unpainted railway vehicle.

In order to achieve the above object, the present disclosure firstly provides an automated wire drawing process of a wire drawing system for a side wall of a railway vehicle, which can automatically finish the wire drawing operation of the side wall of the vehicle body, the specific technical scheme as follows:

A wire drawing process of an automated wire drawing system for a side wall of a railway vehicle, comprising the following steps:

S1, after a vehicle body enters a wire drawing stand, automatically starting the system, a laser measurement system scanning a contour of the vehicle body, determining precise positions of the vehicle body and a door/window, uploading measured position data to a central control system for calculation, comparing with a three-dimensional model of the vehicle body pre-stored in the central control system and being corrected, generating precise wire drawing path.

S2, the central control system converting calculation results and the generated wire drawing path into robot motion commands to be downloaded to a controller of the robot.

S3, the robot performing wire drawing operation of the vehicle body by using the wire drawing device according to instructions.

S4, the vehicle body exiting a workshop or entering into other shop for subsequent treatment, after completion.

Further, the process comprises a passivation operation, the vehicle body after the wire drawing is directly pushed into a passivation shop for the subsequent treatment.

Further, in step S2, the central control system performs on-line planning of wire drawing processing parameters and paths through control algorithm to match the optimal parameters for different vehicle bodies.

Further, the robot is only arranged on one side of the vehicle body, in step S3, the robot performs grinding and wire drawing operation on the side of the vehicle body, after completion, the vehicle body on a first stand and a second stand switches positions, the robot performs the grinding and wire drawing operation on the other side of the vehicle body; or, the two sides of the vehicle body are both provided with the robot, in step S3, the robots on the two sides performs grinding and wire drawing operation on the side wall of the vehicle body on the corresponding side.

Further, the wire drawing operation in step S3 includes rough grinding, fine grinding and wire drawing procedure, tools for each procedure are manipulated by the robot and can be automatically replaced.

The present disclosure simultaneously and further provides an automated wire drawing system for a side wall of a railway vehicle, which can automatically finish the wire drawing operation of the side wall of the vehicle body to achieve the optimal wire drawing effect.

An automated wire drawing system for a side wall of a railway vehicle, comprising a central control system, a robot, a wire drawing device, a guide rail, a laser measurement system, an offline programming software and an electronic control system.

The laser measurement system scans a contour of a vehicle body, determines precise positions of the vehicle body and a door/window, and uploads measured position data to the central control system.

The central control system, provided with the offline programming software, calculates the measured position data, generates a precise wire drawing path, converts the wire drawing path into robot motion command to be downloaded into a controller of the robot, and controls other running programs.

The robot, wherein the controller of the robot receives instructions from the central control system, and the robot controls the wire drawing device to perform vehicle body wire drawing on the vehicle body.

The electronic control system adjusts the processing parameters such as feed speed, pressure, rotation speed in real time.

The guide rail is a vehicle body running railway.

Further, the laser measurement device is arranged on an arm of the robot.

Further, the wire drawing device includes a grinding tool to perform grinding operation.

Further, the grinding tool is a thousand impeller.

Further, the system comprises an abrasive detection access device.

In summary, the automated wire drawing system for the side wall of the railway vehicle and the wire drawing process provided by the present disclosure, compared with the prior art, has the following advantages:

1. The system adopts international leading technology such as offline programming, online calibration and robot vision, to ensure that the system has high flexible intelligence. It can not only realize the wire drawing operation on the surface of different vehicle types, but also ensure the consistency of the processing quality. The human-computer interaction is friendly, and the operation is easy.

2. The industrial robot has relatively high processing flexibility, and can realize wire drawing operation on the surface of different vehicle types and different shapes. The blade of the thousand impeller can adopts the local deformation of the plate during the grinding, with good conformal performance, and the minimum amount of thinning can be guaranteed.

3. The high-performance laser measurement system ensures the accurate measurement of the actual manufacturing error of the vehicle body before the wire drawing operation, and performs online planning of the processing parameters and paths of the wire drawing through the control algorithm, to ensure that different vehicle bodies are matched with the optimal wire drawing parameters.

4. The tools for each procedure of rough grinding, fine grinding and wire drawing can be automatically replaced, without manual intervention, the safety and working efficiency of the system is high.

5. The automated flexible and intelligent wire drawing operation can be realized, the change of the surface shape of the work piece within a certain range can be automatically adopted. A constant normal wire drawing force is always maintained, the processing parameters such as feed speed, pressure and rotation speed is adjusted in real time by the electronic control system, to achieve the optimal wire drawing effect.

### BRIEF DESCRIPTION OF THE DRAWINGS

FIG. 1 is a structural plan schematic diagram of an automated wire drawing system for a side wall of a railway vehicle of the present disclosure;

FIG. 2 is a structural stereoscopic schematic diagram I of the automated wire drawing system for the side wall of the railway vehicle of the present disclosure;

FIG. 3 is a structural stereoscopic schematic diagram II of the automated wire drawing system for the side wall of the railway vehicle of the present disclosure.

Wherein: 1. central control room 2. online wheel diameter detecting device 3. robot 4. tool magazine 5. robot guide rail 6. vehicle body 7. railway 8. tractor stand 9. wire drawing device 10. tool calibration stand 11. ground dust removing device 12. first side 13. dust removing air duct

### DETAILED DESCRIPTION

The following is further described in details with the present disclosure with accompanying drawings and embodiments.

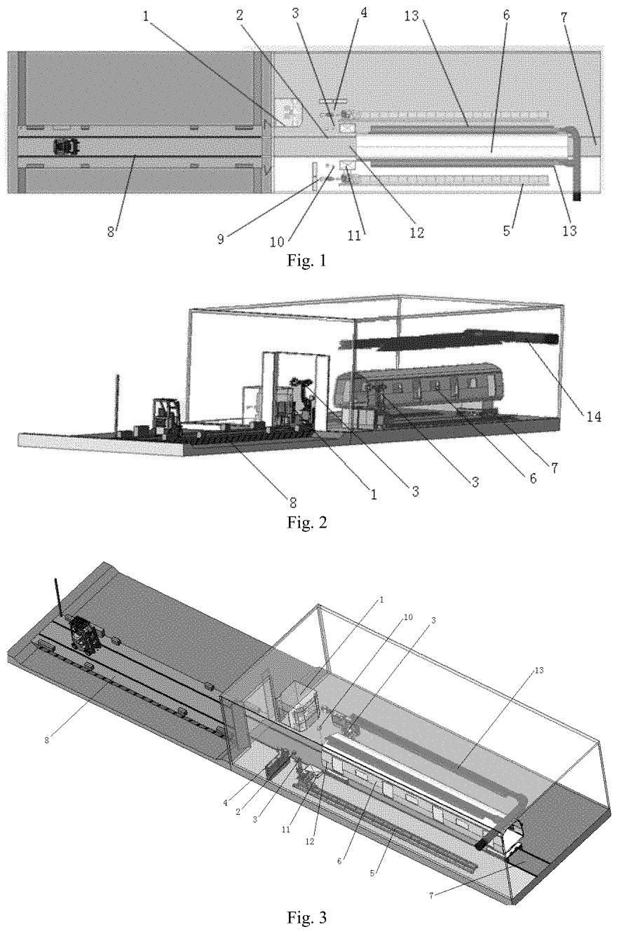

As shown in FIG. 1 to FIG. 3, an automated wire drawing system for a side wall of a railway vehicle provided by the present disclosure comprises a central control system, a robot 3, a wire drawing device 9, a railway 7, a laser measurement system, offline programming software and an electronic control system.

The laser measurement system processes online calibration, scans the contour of a vehicle body, determines the exact position of the vehicle body and a door/a window, and uploads the measured position data to the central control system.

The central control system is provided with the offline programming software, and calculates the measured position data, plans wire drawing process parameters and path online according to the built-in control algorithm to generate precise wire drawing path. It ensures that different vehicle bodies are matched with the optimal wire drawing parameters, the optimal wire drawing parameters are converted into robot motion commands and the robot motion commands are downloaded to a controller of the robot. And the central control system controls other running programs.

The robot 3: the controller of the robot 3 receives the instructions of the central control system, and controls the wire drawing device 9 to wire draw the vehicle body.

The electronic control system adjusts the process parameters such as feed rate, pressure, rotation speed in real time.

Railway 7 is a vehicle body running railway.

In the present embodiment, a wire drawing workshop for the side wall of the vehicle body of the railway vehicle mainly undertakes the surface finishing and wire drawing task of the unpainted aluminum alloy vehicle body. Two railways 7 are arranged inside the workshop. Each railway 7 is arranged with one stand, there are two stands in total. Each stand can be arranged with a construction stand, and each construction stand comprises one wire drawing stand for wire drawing. The arranged construction stand meets the production operation of the vehicle body with a length of 20 m to 25 m. The workshop of the vehicle body has two spans in total. In the present embodiment, the workshop approximately covers land with 30m*15m (length*width). In the present embodiment, the wire drawing workshop for the side wall of the vehicle body of the railway vehicle is an enclosed workshop. The front end has two workshop doors, which can let two vehicle bodies 6 drive into the wire drawing site in the same time. There is a load-bearing beam between two workshop doors, which cannot be removed or transformed.

Taking a wire drawing stand inside the workshop as an example, the automated wire drawing system for the side wall of the railway vehicle is described in details. As shown in FIG. 1 to FIG. 3, the railway 7 is divided into two sections, one section is on the side of a tractor stand 8, and the other section is inside the wire drawing site. And the two sections are of an integral structure. The vehicle loading operation can be performed on the tractor stand 8. The vehicle body 6 is placed on and loaded by a frame trolley to enter into the wire drawing site through the railway 7, and the position of the vehicle body 6 is fixed, the robot 3 performs wire drawing operation on the vehicle body. Inside the wire drawing site, the outer side of the railway 7 is provided with a robot guide rail 13. The bottom of the robot 3 is provided with a structure cooperating with the robot guide rail 13, and the robot 3 can run smoothly along the direction of the vehicle body on the robot guide rail. Inside the wire drawing site, a central control room, i.e. a machine room, is arranged close to the separation between the side of the tractor stand 8 and the wire drawing site. The central control system 1 is arranged inside the central control room and is a general control system. The central control system comprises the offline programming software, and the measured position data is calculated, wire drawing process parameters and path are planned online according to the built-in control algorithm, to generate precise wire drawing path. It ensures that different vehicle bodies are matched with the optimal wire drawing parameters, the optimal wire drawing parameters are converted into robot motion commands and the robot motion commands are downloaded to the controller of the robot. And the central control system controls other running programs.

Inside the wire drawing site, the railway 7 is divided into a first side 12 and a second side, the first side 12 and the second side can be specifically distributed according to the running direction of the vehicle body. Generally speaking, the first side 12 is at the end of vehicle head, and the second side is at the end of vehicle tail. During practical operation, the location of the first side 12 and the second side can be freely defined. An online wheel diameter detecting device 2 is arranged on the railway 7 at the end of the first side 12, to detect whether or not the wire drawing device 9 is abraded. The positioning program of the robot 3 is adjusted in time according to the detected abraded result, and precise wire drawing operation is performed on the side wall of the vehicle body 6. On the same side, the robot 3 is arranged on the front side of the end of the robot guide rail 5, the bottom of the robot 3 can run on the robot rail 5. The end of the robot guide rail 5 is respectively provided with a tool magazine 4 and a tool calibration stand 10. Various tools for fine grinding, rough grinding, wire drawing and etc are accurately placed inside the tool magazine 4 according to the specified position, the placing position is specified by the tool calibration stand 10, and the robot can pick and place various tools from the tool magazine 4 according to the instructions, to do corresponding operation. And the tools for each procedure such as rough grinding, fine grinding and wire drawing can be automatically replaced, without manual intervention, the safety and working efficiency of the system is improved. The tools required for various wire drawing operation such as rough grinding, fine grinding and wire drawing is placed according to regulations, so that the robot 3 can automatically replace the tools for each procedure without manual intervention, the safety and working efficiency of the system is improved. The setting positions of the tool magazine 4 and the tool calibration stand 10 can be set as needed. The wire drawing operation includes a grinding operation, so the wire drawing device 9 includes a grinding tool for grinding the vehicle body. In the present embodiment, the grinding tool is a thousand impeller. Blades of thousand impeller can adapted to the local deformation of the plate during the grinding, with good conformal performance, and the minimum amount of thinning can be guaranteed. The system also includes an abrasive detection access device, the using condition of the abrasive is periodically monitored for timely replenishment.

A ground dust removing device 11 is further arranged inside the wire drawing site. In the present embodiment of the present disclosure, both side of the first side 12 of the railway 7 is respectively provided with one ground dust removing device 11 for collecting and processing the dust generated during the processing operation, and it can prevent explosion with the flame due to excessive high dust concentration of air. At the same time, a dust removing air duct 15 is arranged inside the workshop, using the wind power to remove the dust. As shown in FIG. 2, the dust removing air duct 15 has two paths which are respectively arranged at the top of the workshop faces the outer side of two railways 7, and integrated into one dust removing air duct at the tail.

The robot 3 adopts the existing common industry operation robot, automatically completing the wire drawing operation such as rough grinding, fine grinding and wire drawing according to the instructions. The arm of the robot 3 is provided with a laser testing system, the contour of the vehicle body is scanned, the precise position of the vehicle body and door/window is determined. And the measured position data is uploaded to the central control system to do calculation and to generate precise wire drawing path, and then is converted into the robot motion commands to be downloaded into the controller of the robot. The robot grips the wire drawing device to perform wire drawing of vehicle body. The whole process is automatically completed without manual intervention.

The vehicle body 6 to be processed is loaded on the frame trolley at the tractor stand 8 side, enters into the wire drawing site through the railway 7 and is positioned on the wire drawing stand, and the robot performs grind and wire drawing on the vehicle body 6. When two sides of the railway 7 are both provided with the robots 3, the robots 3 on the two sides perform operation on the two sides of the vehicle body 6 at the same time. When the robot 3 is only arranged on one side of the railway 7, the side of the vehicle body on the first and second stand is grinded by the robot, the vehicle body on the first and second stand switches positions by the frame trolley, and then the other side of the vehicle body on the first and second stand is grinded and wire drawn by the robot 3. After completion, the vehicle body returns to the tractor stand 8 from the first and second stand by the frame trolley. If the passivation treatment is needed after the wire drawing, the frame trolley is directly pushed into the passivation shop from the side of the tractor station 8 by a trailer to finish the subsequent treatment. The wire drawing shop and the passivation shop are isolated by an automatic rolling shutter to reduce the running distance, making the workshop layout compact, and saving land and transportation cost.

Besides the provided automated wire drawing system for side wall of the vehicle body of the railway vehicle, a wire drawing process using the automated wire drawing system for operation is provided the present disclosure, which can perform automatic wire drawing operation without any manual intervention. The wire drawing process includes the following steps:

S1, after the vehicle body enters the wire drawing stand, automatically starting the system, the laser measurement system scanning the contour of the vehicle body, determining the precise positions of the vehicle body and door/window, uploading the measured position data to the central control system for calculation, and generating the precise wire drawing path.

S2, the central control system converting the calculation results and the generated wire drawing path into the robot motion command to be downloaded to the controller of the robot.

S3, the robot performing wire drawing operation of the wire drawing device by using the wire drawing device according to the instructions; the wire drawing operation including rough grinding, fine grinding and wire drawing procedure, the robot automatically selecting the using tools and automatically replacing the tools according to the different operation types and procedures, without manual intervention.

S4, the vehicle body exiting the workshop or entering into other shop for subsequent treatment, after completion.

It should be noted that, in step S3, if when the robot is only arranged on one side of the railway, that is, when the robot is on one side of the vehicle body, the robot performs grinding and wire drawing operation on the side of the vehicle body on the first and second stand. After completion, the vehicle body on the first and second stand switches positions by the frame trolley, and the robot performs grinding and wire drawing operation on the other side of the vehicle body on the first and second stand. When two sides of railway are both provided with the robot, that is, when the two sides of the vehicle body are both provided with the robot, the grinding and wire drawing operation id performed on the two sides at the same time. And the wire drawing operation in step 3 includes rough grinding, fine grinding and wire drawing procedure. The tools of each procedure are manipulated by the robot and can be automatically replaced.

At the same time, in step S3, the wire drawing device can perform online real-time measurement. For example, the online wheel diameter detecting device is used to detect whether or not the wire drawing device is abrasive. The parameter compensation is performed according to the detected abrasion condition, the positioning program is adjusted in time, and the precise wire drawing operation is performed on the side wall of the vehicle body.

If the passivation treatment is needed after the wire drawing, the vehicle body after the wire drawing is directly pushed into the passivation shop from the tractor stand by the frame trolley to finish the subsequent treatment. The passivation shop and the wire drawing shop are isolated by the automatic rolling shutter.

In summary, the automated wire drawing system for the side wall of the railway vehicle and the wire drawing process provided by the present disclosure, compared with the prior art, have the following advantages:

1. The system adopts international leading technology such as offline programming, online calibration and robot vision, to ensure that the system has high flexible intelligence. It can not only realize the wire drawing operation on the surface of different vehicle types, but also ensure the consistency of the processing quality. The human-computer interaction is friendly, and the operation is easy.

2. The industrial robot has relatively high processing flexibility, and can realize wire drawing operation on the surface of different vehicle types and different shapes. The blade of the thousand impeller can adopts the local deformation of the plate during the grinding, with good conformal performance, and the minimum amount of thinning can be guaranteed.

3. The high-performance laser measurement system ensures the accurate measurement of the actual manufacturing error of the vehicle body before the wire drawing operation, and performs online planning of the processing parameters and paths of the wire drawing through the control algorithm, to ensure that different vehicle bodies are matched with the optimal wire drawing parameters.

4. The tools for each procedure of rough grinding, fine grinding and wire drawing can be automatically replaced, without manual intervention, the safety and working efficiency of the system is high.

5. The automated flexible and intelligent wire drawing operation can be realized, the change of the surface shape of the workpiece within a certain range can be automatically adopted. A constant normal wire drawing force is always maintained, the processing parameters such as feed speed, pressure and rotation speed is adjusted in real time by the electronic control system, to achieve the optimal wire drawing effect.

As described above, a similar technical solution can be derived in combination with the presented solution content. But any and all modifications, equivalents, and modifications of the foregoing embodiments are within the scope of the present disclosure without departing from the spirit of the technical solution of the present disclosure in accordance with the technical details of the present disclosure.

1. A wire drawing process of an automated wire drawing system for a side wall of a railway vehicle, comprising following steps:
S1, after a vehicle body enters a wire drawing stand, automatically starting the system, a laser measurement system scanning a contour of the vehicle body, determining precise positions of the vehicle body and a door/window, uploading a position data measured to a central control system for calculation, comparing with a three-dimensional model of the vehicle body pre-stored in the central control system for calibration, and generating a wire drawing path precisely;
S2, the central control system converting calculation results and the wire drawing path into a robot motion command and downloading the robot motion command to a controller of a robot;
S3, the robot performing a wire drawing operation of the vehicle body by using a wire drawing device according to the robot motion command;
S4, after completion, the vehicle body exiting a workshop or entering into other workshop for a subsequent treatment.

2. The wire drawing process of the automated wire drawing system for the side wall of the railway vehicle according to claim 1, further comprising a passivation operation,
wherein, after the wire drawing operation is completed, the vehicle body is directly pushed into a passivation workshop for the subsequent treatment.

3. The wire drawing process of the automated wire drawing system for the side wall of the railway vehicle according to claim 1, wherein, in step S1, the central control system performs an online planning of a wire drawing processing parameter and the wire drawing path through a control algorithm, each vehicle bodies are respectively matched with optimal parameters.

4. The wire drawing process of the automated wire drawing system for the side wall of the railway vehicle according to claim 1, wherein, the robot is only arranged on one side of the vehicle body,
in step S3, the robot performs a grinding and the wire drawing operation on a side of the vehicle body,
after completion, sides of the vehicle body on a first stand and s second stand are interchanged, the robot performs the grinding and wire drawing operation on the other side of the vehicle body;
or, two sides of the vehicle body are both provided with the robot, in step S3, robots on the two sides performs the grinding and wire drawing operation on a corresponding side wall of the vehicle body.

5. The wire drawing process of the automated wire drawing system for the side wall of the railway vehicle according to claim 1, wherein, the wire drawing operation in step S3 includes a rough grinding procedure, a fine grinding procedure and a wire drawing procedure, tools for each procedure are manipulated by the robot and can be automatically replaced.

6. An automated wire drawing system for a side wall of a railway vehicle, comprising a central control system, a robot, a wire drawing device, a guide rail, a laser measurement system, an offline programming software and an electronic control system, wherein,
the laser measurement system scans a contour of a vehicle body, determines precise positions of the vehicle body and a door/window, and uploads a measured position data to the central control system;
the central control system, provided with the offline programming software, calculates the measured position data, generates a wire drawing path precisely, converts the wire drawing path into a robot motion command and downloads the robot motion command into a controller of the robot, and controls other running programs;
the robot, wherein the controller of the robot receives the robot motion command from the central control system, and the robot controls the wire drawing device to perform the wire drawing operation on the vehicle body;
the electronic control system adjusts processing parameters comprising feed speed, pressure, rotation speed in real time;
the guide rail is a vehicle body running railway.

7. The automated wire drawing system for the side wall of the railway vehicle according to claim 6, wherein, the laser measurement device is arranged on an arm of the robot.

8. The automated wire drawing system for the side wall of the railway vehicle according to claim 6, wherein, the wire drawing device includes a grinding tool to perform a grinding operation.

9. The automated wire drawing system for the side wall of the railway vehicle according to claim 6, wherein, the grinding tool is a thousand impeller.

10. The automated wire drawing system for the side wall of the railway vehicle according to claim 6, further comprises an abrasive detection access device.
